(19) United States
(12) Patent Application Publication
(10) Pub. No.: US 2015/0063259 A1
(43) Pub. Date: Mar. 5, 2015

(54) METHOD AND APPARATUS FOR PARTIAL BANDWIDTH CARRIER AGGREGATION

(71) Applicant: QUALCOMM Incorporated, San Diego, CA (US)

(72) Inventors: Amir Aminzadeh Gohari, San Diego, CA (US); Srinivasan Balasubramanian, San Diego, CA (US); Mariam Motamed, Redwood City, CA (US)

(21) Appl. No.: 14/471,679

(22) Filed: Aug. 28, 2014

Related U.S. Application Data
(60) Provisional application No. 61/872,480, filed on Aug. 30, 2013.

(51) Int. Cl. H04W 72/14; H04W 28/20

(52) U.S. Cl. CPC H04W 72/14; H04W 28/20
USPC 370/329

(57) ABSTRACT

Systems and methods which provide partial bandwidth support of secondary cells for Carrier Aggregation (referred to as Partial Bandwidth Carrier Aggregation) are disclosed. Partial Bandwidth Carrier Aggregation according to embodiments implements wireless links using a plurality of cells with a user equipment (UE), as a means to improve the UE throughput, by using of a portion of the secondary cell bandwidth to accommodate bandwidth limitations of the UE and thereby facilitates the aggregation of component carriers (or portions thereof) when Carrier Aggregation would not otherwise be possible.

### CROSS-REFERENCE TO RELATED APPLICATIONS

This application claims the benefit of U.S. Provisional Patent Application No. 61/872,480, entitled, “METHOD AND APPARATUS FOR PARTIAL BANDWIDTH CARRIER AGGREGATION”, filed on Aug. 30, 2013, the disclosure of which is expressly incorporated by reference herein in its entirety.

### BACKGROUND

1. Field

Aspects of the present disclosure relate generally to wireless communication systems, and more particularly, to providing partial bandwidth support of secondary cells in carrier aggregation deployments.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the disclosure, a method of wireless communication comprises assigning a portion of communication bandwidth of a secondary cell (SCell) to a user equipment (UE), wherein the portion of communication bandwidth of the SCell is less than a full bandwidth of the SCell. The method further comprises sending information for the assignment of the portion of the SCell communication bandwidth to the UE using a primary cell (PCell) in communication with the UE, and providing data communication with the UE using the portion of the SCell communication bandwidth in accordance with the information.

In an additional aspect of the disclosure, an apparatus configured for wireless communication comprises means for assigning a portion of communication bandwidth of a secondary cell (SCell) to a user equipment (UE), wherein the portion of communication bandwidth of the SCell is less than a full bandwidth of the SCell. The apparatus further comprises means for sending information for the assignment of the portion of the SCell communication bandwidth to the UE using a primary cell (PCell) in communication with the UE, and means for providing data communication with the UE using the portion of the SCell communication bandwidth in accordance with the information.

In an additional aspect of the disclosure, a computer program product has a computer-readable medium having program code recorded thereon. This program code includes program code to assign a portion of communication bandwidth of a secondary cell (SCell) to a user equipment (UE), wherein the portion of communication bandwidth of the SCell is less than a full bandwidth of the SCell. The program code further includes program code to send information for the assignment of the portion of the SCell communication bandwidth to the UE using a primary cell (PCell) in communication with the UE, and program code to provide data communication with the UE using the portion of the SCell communication bandwidth in accordance with the information.

In an additional aspect of the disclosure, an apparatus includes at least one processor and a memory coupled to the processor. The processor is configured to assign a portion of communication bandwidth of a secondary cell (SCell) to a user equipment (UE), wherein the portion of communication bandwidth of the SCell is less than a full bandwidth of the SCell. The processor is further configured to send information for the assignment of the portion of the SCell communication bandwidth to the UE using a primary cell (PCell) in communication with the UE, and to provide data communication with the UE using the portion of the SCell communication bandwidth in accordance with the information.

### BRIEF DESCRIPTION OF THE DRAWINGS

FIG. 1 is a block diagram conceptually illustrating an example of a mobile communication system.

FIG. 2 is a block diagram conceptually illustrating an example of a downlink frame structure in a mobile communication system.

FIG. 3 is a block diagram conceptually illustrating an exemplary frame structure in uplink LTE/-A communications.

FIG. 4 is a block diagram conceptually illustrating a design of a base stationleNB and a UE configured according to one aspect of the present disclosure.

FIGS. 5A and 5B is a diagrammatic illustration of operation of Partial Bandwidth Carrier Aggregation according to an aspect of the disclosure.

FIGS. 6A and 6B illustrate the placement of certain physical channels within a downlink and uplink.

FIG. 7 is a block diagram illustrating a base station/eNB configured according to one aspect of the present disclosure.

FIG. 8 is a flow diagram illustrating operation to provide Partial Bandwidth Carrier Aggregation according to an aspect of the disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

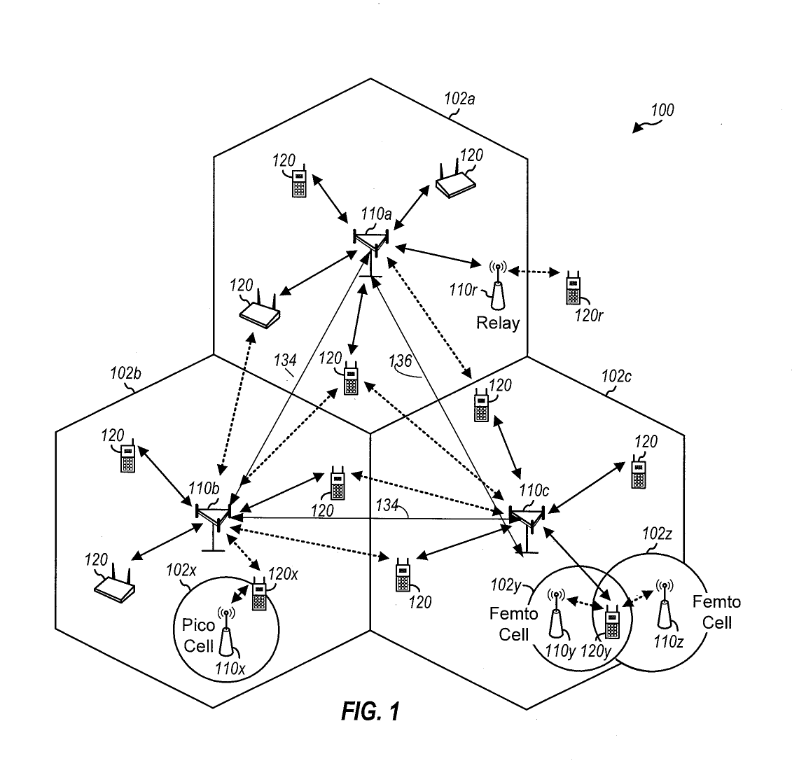

FIG. 1 shows wireless network 100 for communication, which may be an LTE-A network. Wireless network 100 includes a number of evolved node Bs (eNBs) 110 and other network entities. An eNB may be a station that communicates with the UEs and may also be referred to as a base station, a node B, an access point, and the like. Each eNB 110 may provide communication coverage for a particular geographic area. In 3GPP, the term “cell” can refer to this particular geographic coverage area of an eNB and/or an eNB subsystem serving the coverage area, depending on the context in which the term is used.

An eNB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, eNBs 110a, 110b and 110c are macro eNBs for macro cells 102a, 102b and 102c, respectively. eNB 110x is a pico eNB for pico cell 102x. And, eNBs 110y and 110z are femto eNBs for femto cells 102y and 102z, respectively. An eNB may support one or multiple (e.g., two, three, four, and the like) cells.

Wireless network 100 also includes relay stations. A relay station is a station that receives a transmission of data and/or other information from an upstream station (e.g., an eNB, a UE, or the like) and sends a transmission of the data and/or other information to a downstream station (e.g., another UE, another eNB, or the like). A relay station may also be a UE that relays transmissions for other UEs. In the example shown in FIG. 1, relay station 110r may communicate with eNB 110a and UE 120r, in which relay station 110r acts as a relay between the two network elements (eNB 110a and UE 120r) in order to facilitate communication between them. A relay station may also be referred to as a relay eNB, a relay, and the like.

Wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

UEs 120 are dispersed throughout wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for a corresponding system bandwidth of 1.4, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 5, 10, 15, or 20 MHz, respectively.

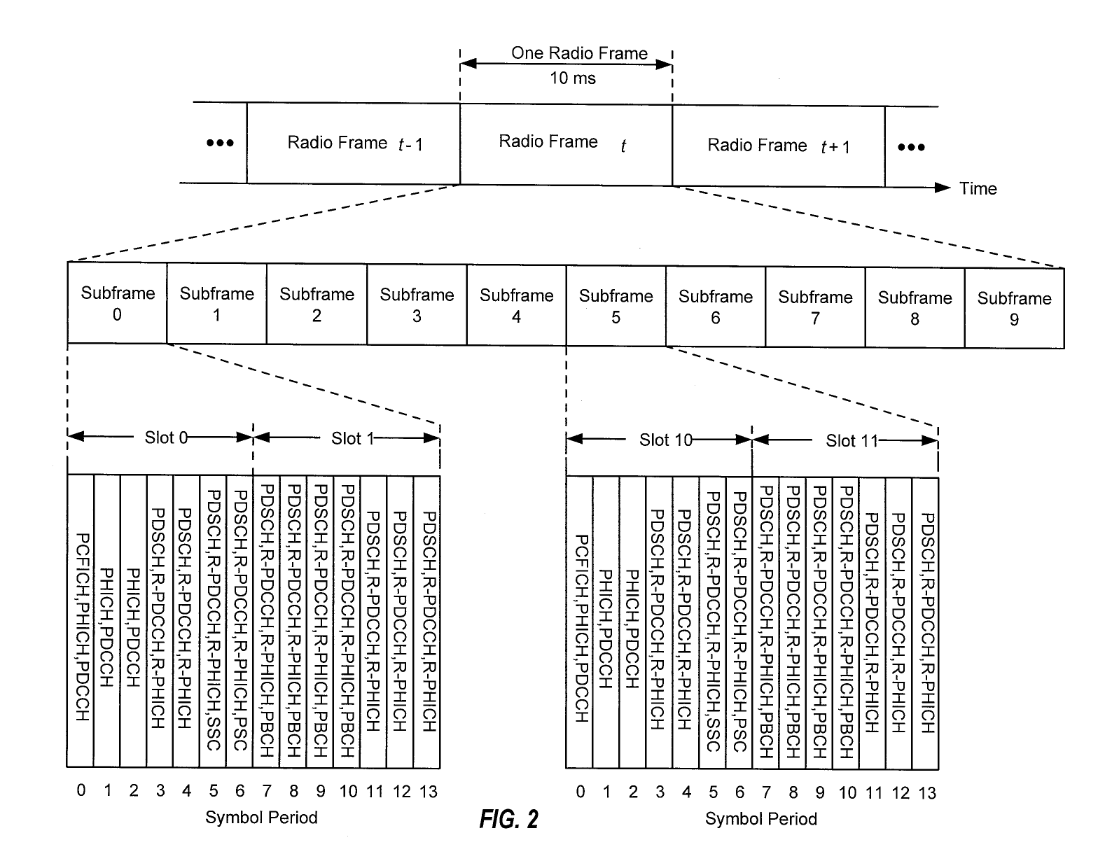

FIG. 2 shows a downlink frame structure used in LTE/-A. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE/-A, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

In addition to sending PHICH and PDCCH in the control section of each subframe, i.e., the first symbol period of each subframe, the LTE-A may also transmit these control-oriented channels in the data portions of each subframe as well. As shown in FIG. 2, these new control designs utilizing the data region, e.g., the Relay-Physical Downlink Control Channel (R-PDCCH) and Relay-Physical HARQ Indicator Channel (R-PHICH) are included in the later symbol periods of each subframe. The R-PDCCH is a new type of control channel utilizing the data region originally developed in the context of half-duplex relay operation. Different from legacy PDCCH and PHICH, which occupy the first several control symbols in one subframe, R-PDCCH and R-PHICH are mapped to resource elements (REs) originally designated as the data region. The new control channel may be in the form of Frequency Division Multiplexing (FDM), Time Division Multiplexing (TDM), or a combination of FDM and TDM.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

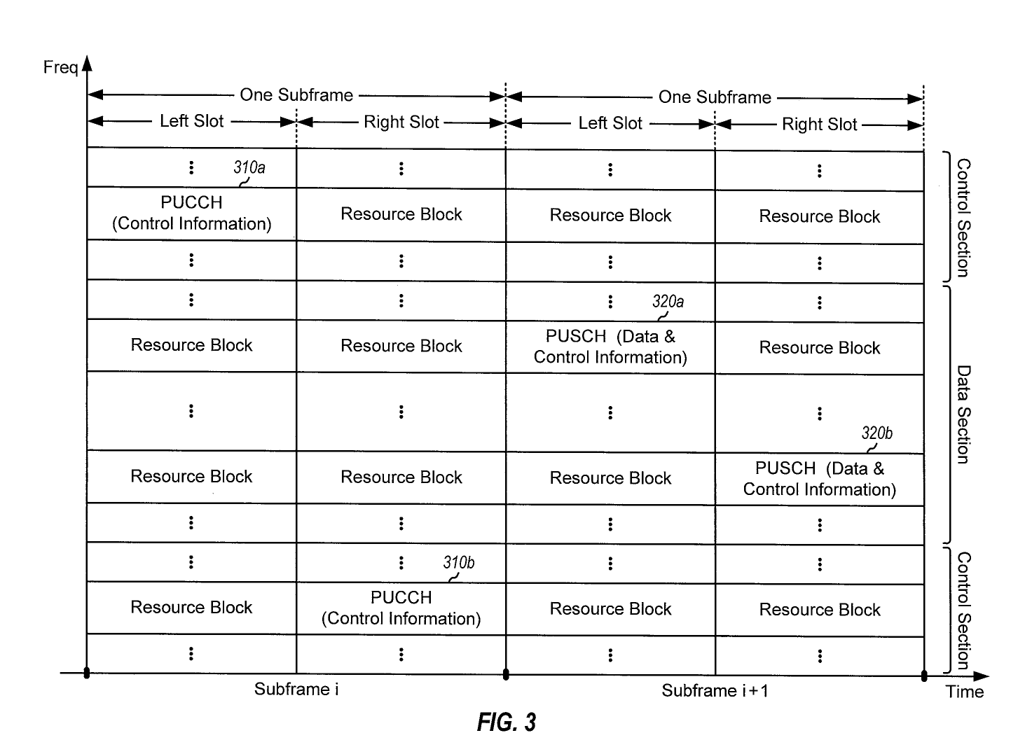

FIG. 3 is a block diagram illustrating exemplary frame structure 300 in uplink long term evolution (LTE/-A) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNode B. The UE may transmit control information in a Physical Uplink Control Channel (PUCCH) on assigned resource blocks 310a and 310b in the control section. The UE may transmit only data or both data and control information in a Physical Uplink Shared Channel (PUSCH) on assigned resource blocks 320a and 320b in the data section. An uplink transmission may span both slots of a subframe and may hop across frequency as shown in FIG. 3.

Referring back to FIG. 1, wireless network 100 uses the diverse set of eNBs 110 (i.e., macro eNBs, pico eNBs, femto eNBs, and relays) to improve the spectral efficiency of the system per unit area. Because wireless network 100 uses such different eNBs for its spectral coverage, it may also be referred to as a heterogeneous network. Macro eNBs 110a-c are usually carefully planned and placed by the provider of wireless network 100. Macro eNBs 110a-c generally transmit at high power levels (e.g., 5 W-40 W). Pico eNB 110x and relay station 110r, which generally transmit at substantially lower power levels (e.g., 100 mW−2 W), may be deployed in a relatively unplanned manner to eliminate coverage holes in the coverage area provided by macro eNBs 110a-c and improve capacity in the hot spots. Femto eNBs 110y-z, which are typically deployed independently from wireless network 100 may, nonetheless, be incorporated into the coverage area of wireless network 100 either as a potential access point to wireless network 100, if authorized by their administrator(s), or at least as an active and aware eNB that may communicate with other eNBs 110 of wireless network 100 to perform resource coordination and coordination of interference management. Femto eNBs 110y-z typically also transmit at substantially lower power levels (e.g., 100 mW-2 W) than macro eNBs 110a-c.

In operation of a heterogeneous network, such as wireless network 100, each UE is usually served by the eNB of wireless network 100 with the better signal quality, while the unwanted signals received from the other eNBs are treated as interference. While such operational principals can lead to significantly sub-optimal performance, gains in network performance are realized in wireless network 100 by using intelligent resource coordination among eNBs 110, better server selection strategies, and more advanced techniques for efficient interference management.

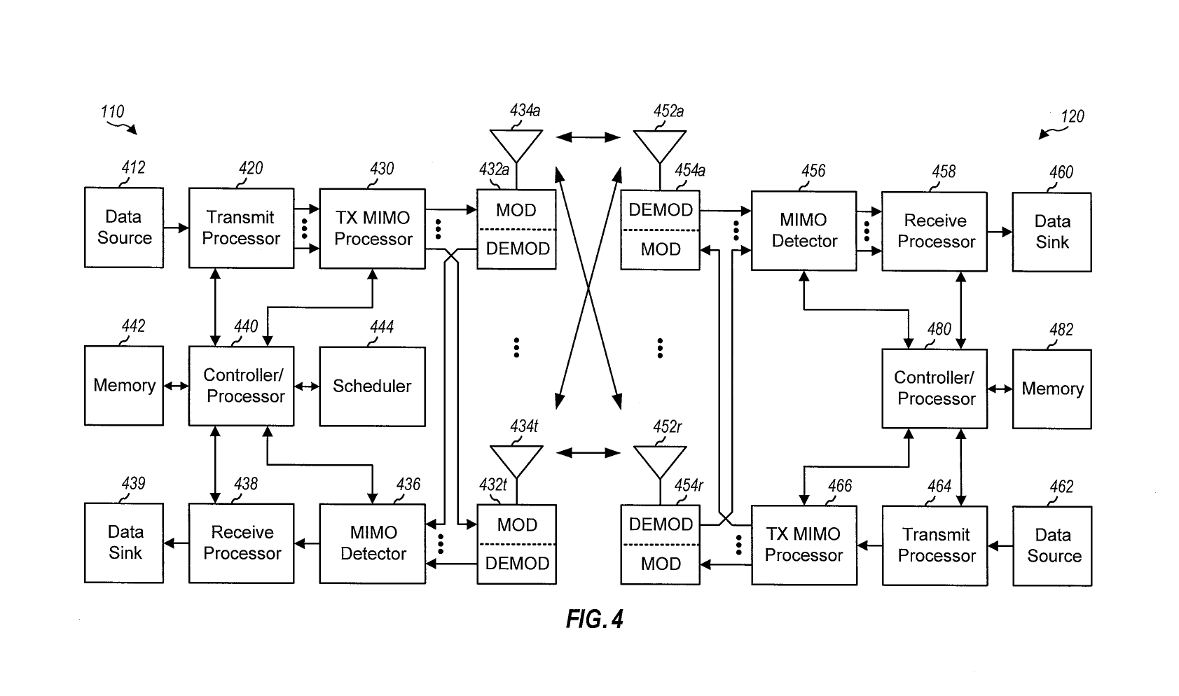

FIG. 4 shows a block diagram of a design of base station/eNB 110 and UE 120, which may be one of the base stations/eNBs and one of the UEs in FIG. 1. For a restricted association scenario, eNB 110 may be macro eNB 110c in FIG. 1, and UE 120 may be UE 120y. eNB 110 may also be a base station of some other type. eNB 110 may be equipped with antennas 434a through 434t, and UE 120 may be equipped with antennas 452a through 452r.

It should be appreciated that, although the illustrated embodiment of FIG. 4 shows a single eNB 110 in communication with UE 120, when implementing Partial Bandwidth Carrier Aggregation according to embodiments herein a plurality of eNBs 110 (e.g., eNB 110a, eNB 110b, eNB 110c, eNB 110x, eNB 110y, and/or eNB 110z) may be in communication with UE 120, such as where the eNBs in communication with UE 120 are operating under common control or are operated as a logical eNB. Accordingly, a plurality of eNBs 110 configured as illustrated in FIG. 4 may be in communication with UE 120 shown in FIG. 4 in operation according to embodiments herein.

At eNB 110, transmit processor 420 may receive data from data source 412 and control information from controller/processor 440. The control information may be for the PBCH, PCFICH, PHICH, PDCCH, etc. The data may be for the PDSCH, etc. Transmit processor 420 may process (e.g., encode and symbol map) the data and control information to obtain data symbols and control symbols, respectively. Transmit processor 420 may also generate reference symbols, e.g., for the PSS, SSS, and cell-specific reference signal. Transmit (TX) multiple-input multiple-output (MIMO) processor 430 may perform spatial processing (e.g., precoding) on the data symbols, the control symbols, and/or the reference symbols, if applicable, and may provide output symbol streams to modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via antennas 434a through 434t, respectively.

At UE 120, antennas 452a through 452r may receive the downlink signals from eNB 110 and may provide received signals to demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. MIMO detector 456 may obtain received symbols from all demodulators 454a through 454r, perform MIMO detection on the received symbols if applicable, and provide detected symbols. Receive processor 458 may process (e.g., demodulate, deinterleave, and decode) the detected symbols, provide decoded data for UE 120 to data sink 460, and provide decoded control information to controller/processor 480.

On the uplink, at UE 120, transmit processor 464 may receive and process data (e.g., for the PUSCH) from data source 462 and control information (e.g., for the PUCCH) from controller/processor 480. Transmit processor 464 may also generate reference symbols for a reference signal. The symbols from transmit processor 464 may be precoded by TX MIMO processor 466 if applicable, further processed by demodulators 454a through 454r (e.g., for SC-FDM, etc.), and transmitted to eNB 110. At eNB 110, the uplink signals from UE 120 may be received by antennas 434, processed by modulators 432, detected by MIMO detector 436 if applicable, and further processed by receive processor 438 to obtain decoded data and control information sent by UE 120. Processor 438 may provide the decoded data to data sink 439 and the decoded control information to controller/processor 440.

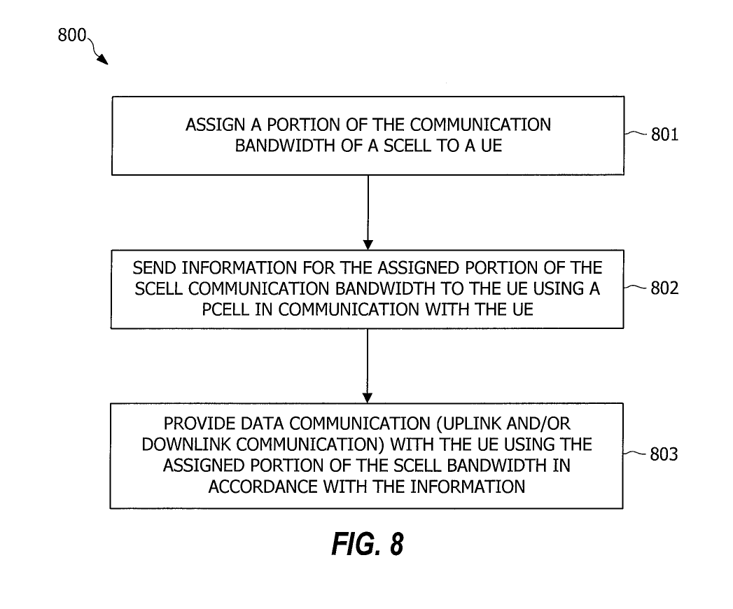

Controllers/processors 440 and 480 may direct the operation at eNB 110 and UE 120, respectively. Controller/processor 440 and/or other processors and modules at eNB 110 may perform or direct the execution of various processes for the techniques described herein. Controllers/processor 480 and/or other processors and modules at UE 120 may also perform or direct the execution of the functional blocks illustrated in FIGS. 8 and 9, and/or other processes for the techniques described herein. Memories 442 and 482 may store data and program codes for eNB 110 and UE 120, respectively. Scheduler 444 may schedule UEs for data transmission on the downlink and/or uplink.

Various techniques for serving the ever increasing demand for delivery of information using wireless links, such as provided by the foregoing wireless network, have been developed. One such technique, referred to as Carrier Aggregation (CA), has been to implement wireless links between one or more base stations and a UE on a plurality of carriers. In particular, Carrier Aggregation was defined in Long Term Evolution (LTE) Release 10 (LTE-A) as a means to improve the UE throughput, wherein the aggregated carriers are base station component carriers (e.g., uplink and downlink) providing a primary cell (PCell) and base station component carriers (e.g., uplink and/or downlink) providing one or more secondary cells (SCell). The PCell is the “anchor” carrier and is always active with respect to the UE communication session, while the SCells can be configured/deconfigured and activated/deactivated depending on the UE data traffic. Such Carrier Aggregation is not limited to the use of two carriers (i.e., PCell and SCell), and thus may be implemented with three carriers (i.e., PCell and 2 SCells), four carriers (i.e., PCell and 3 SCells), etc.

In order to robustly serve the demand for mobile broadband access by various users, UE 120 and eNB 110 are adapted to implement Carrier Aggregation. For example, eNB 110a (referring again to FIG. 1) may operate as a primary cell (PCell) with respect to UE 120 (shown disposed in the lower portion of cell 102a) in a Carrier Aggregation implementation. eNB 110a may support multiple cells for Carrier Aggregation with UE 120 and thus may also configure the capable UEs with a secondary cell (SCell) to provide Carrier Aggregation based increased data throughput. Each serving cell (PCell and SCell) may transmit the common control channels (e.g., PCFICH, PDCCH, and/or PHICH) for the UE configured for secondary component carrier. Alternatively, the PCell, or another SCell, can carry the control signaling for the operation of a SCell via a cross-carrier scheduling feature.

The foregoing PCell provides an “anchor” carrier and preferably remains active with respect to the UE throughout a communication session between eNB 110a and UE 120. However, the SCell (referring only to a single SCell for simplicity), may be configured/deconfigured, activated/deactivated, and scheduled depending on the data traffic associated with UE 120.

The use of such Carrier Aggregation (CA) facilitates much higher peak data rates than a single carrier network offers. For example, current LTE specifications provide for up to five component carriers (CC) with a bandwidth (BW) of up to 20 MHz to be aggregated using Carrier Aggregation. Accordingly, UEs which are capable of utilizing multiple ones of the component carriers, when available in a network, may realize significantly higher data throughput. UEs, however, may have certain communication bandwidth limitations associated therewith which prevent the use of Carrier Aggregation in some situations.

For example, UEs are typically limited in their communication bandwidth capabilities. In particular, there is typically a limitation on the total aggregate bandwidth or bandwidth combinations that a UE supports. UE 120 may have a limitation on the total aggregate bandwidth that the UE supports, and thus may not be able to utilize any or all available component carriers for Carrier Aggregation. For example, UE 120 may be capable of supporting two carriers with a 20 MHz total aggregated bandwidth, possibly with some exceptions (e.g., 15 MHz+5 MHz not being supported). As another example, UE 120 may be capable of supporting 3 carriers with a total aggregate bandwidth of 40 MHz, again possibly with some exceptions (e.g., 20 MHz+15 MHz+5 MHz not being supported). Accordingly, despite the availability of component carriers for implementing Carrier Aggregation with respect to a particular UE which could benefit from additional communication bandwidth, the UE may have insufficient resources to take advantage of such Carrier Aggregation.

Such UE bandwidth limitation problems may manifest themselves in a number of ways. The resources deployed for use with respect to Carrier Aggregation may comprise cells supporting various wireless communication bandwidths. For example, depending upon the available spectrum, interference conditions, network resources, etc., potential secondary component carrier (SCC) implementations of different network operators, radio access technologies, cell clusters, and/or base stations, may provide different communication bandwidth (e.g., 5 MHz, 10 MHz, 15 MHz, 20 MHz, and so on). Different network operators may thus deploy Carrier Aggregation functionality differently, whereby a particular UE roaming from one network to another network may be unable to take advantage of Carrier Aggregation due to these differences. A network operator may modify the Carrier Aggregation deployment over time and/or adapted to accommodate localized conditions, such that differences in Carrier Aggregation functionality exist within the network, whereby a particular UE may be capable of taking advantage of Carrier Aggregation in some portions of the network while not in others. Moreover, legacy UE configurations may have more limitations with respect to Carrier Aggregation associated therewith, and thus as Carrier Aggregation functionality is more fully deployed and/or upgraded (e.g., to provide for multiple SCell aggregation, wherein multiple SCells of a multiple SCell carrier aggregation implementation may be assigned to a UE to provide increased bandwidth through Carrier Aggregation), such legacy UEs may be unable to take advantage of Carrier Aggregation while newer UEs are able to take advantage of the Carrier Aggregation. Thus, as Carrier Aggregation is more fully deployed and continually modernized, UEs are likely to experience situations in which Carrier Aggregation cannot be utilized or cannot be fully utilized due to UE bandwidth limitations.

A UE capable of supporting 20 MHz communication bandwidth may, for example, be anchored on a PCell providing 10 MHz bandwidth while an available SCell provides 15 MHz bandwidth. Because the aggregated bandwidth is beyond the capability of the UE in this example, the UE is unable to take advantage of Carrier Aggregation.

As a more specific example, a UE may be capable of aggregating 2 component carriers (CCs) on band 4 (B4) and band 13 (B13) with a 20 MHz total aggregated bandwidth. A network operator may provide 10 MHz bandwidth on B13 and 5 or 10 MHz bandwidth on B4. In this situation, the UE may be configured with a SCell and achieve higher throughput than single carrier operation. Another network operator, however, may provide 15 MHz or 20 MHz bandwidth cells on B4 (e.g., a network operator in some cities/markets) or the network operator may migrate from 5/10 MHz cells to 15/20 MHz cells (e.g., the network operator may acquire extra bandwidth on B4). In these situations, the UE cannot be configured with a SCell to achieve higher throughput than single carrier operation.

As can be appreciated from the foregoing, situations may exist in which UEs are unable to take advantage of available communication capacity offered by Carrier Aggregation, despite the functionality having been deployed and capacity being available. Accordingly, demand for mobile broadband access may go unserved or underserved and the user experience may be diminished.

A feature of Carrier Aggregation, however, is its ability to use fragmented spectrum. Carrier Aggregation allows network operators to gather spectrum for providing communication services from different parts of one band or from different bands. This aspect of Carrier Aggregation can be particularly advantageous when there is not enough continuous bandwidth in a specific band for a network operator to support single carrier peak data rates. UEs may not only have a limitation on the total aggregate bandwidth that the UE supports, but may further have limitations with respect to particular bandwidth combinations supported which may likewise prevent the use of Carrier Aggregation in some situations.

Accordingly, eNB 110 of the embodiments illustrated in FIG. 4 is further adapted to provide partial bandwidth support of secondary cells for Carrier Aggregation (referred to herein as Partial Bandwidth Carrier Aggregation) according to the concepts herein. As with traditional Carrier Aggregation, Partial Bandwidth Carrier Aggregation according to embodiments herein implements wireless links using a plurality of cells (e.g., base station component carriers providing a plurality of wireless links) with a UE as a means to improve the UE throughput. However, Partial Bandwidth Carrier Aggregation enables the use of a portion of the secondary cell bandwidth to accommodate bandwidth limitations of a UE and thereby facilitates the aggregation of component carriers (or portions thereof) when Carrier Aggregation would not otherwise be possible.

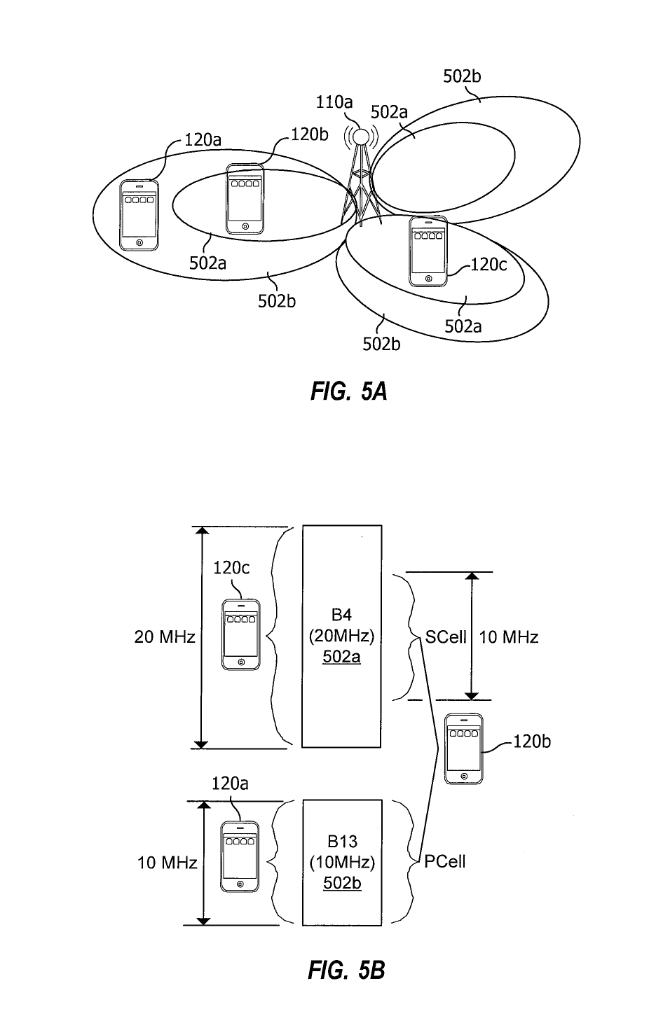

The diagrams of FIGS. 5A and 5B illustrate operation of Partial Bandwidth Carrier Aggregation according to embodiments. In the embodiment illustrated in FIG. 5A, eNB 110a provides communications in cells 502a in band 4 (B4) with a 20 MHz bandwidth. UEs camped on a cell 502a (e.g., UE 120c) therefore assume a 20 MHz bandwidth. Additionally, eNB 110a of FIG. 5A provides communications in cells 502b in band 13 (B13) with a 10 MHz BW. Thus, UEs camped on a cell 502b (e.g., UE 120a) assume a 10 MHz bandwidth. In the present example, UE 120b is capable of supporting two carriers with a 20 MHz total aggregated bandwidth. When UE 120b, although Carrier Aggregation capable, is connected to a cell 502b as a PCell providing 10 MHz bandwidth, the bandwidth provided by cell 502a (i.e., 20 MHz) would exceed the capabilities of the UE if aggregated with that of the PCell (i.e., 10 MHz+20 MHz>20 MHz), and thus typically would not be suitable as a SCell for UE 120b in this situation. However, using Partial Bandwidth Carrier Aggregation according to embodiments herein, UE 120b, in addition to maintaining a connection with cell 502b as a PCell providing 10 MHz bandwidth, can be given a SCell bandwidth of 10 MHz, (out of the total 20 MHz supported by cell 502a) as shown in FIG. 5B, to improve the UE throughput and remain within the capabilities of the UE (i.e., 10 MHz+10 MHz=20 MHz).

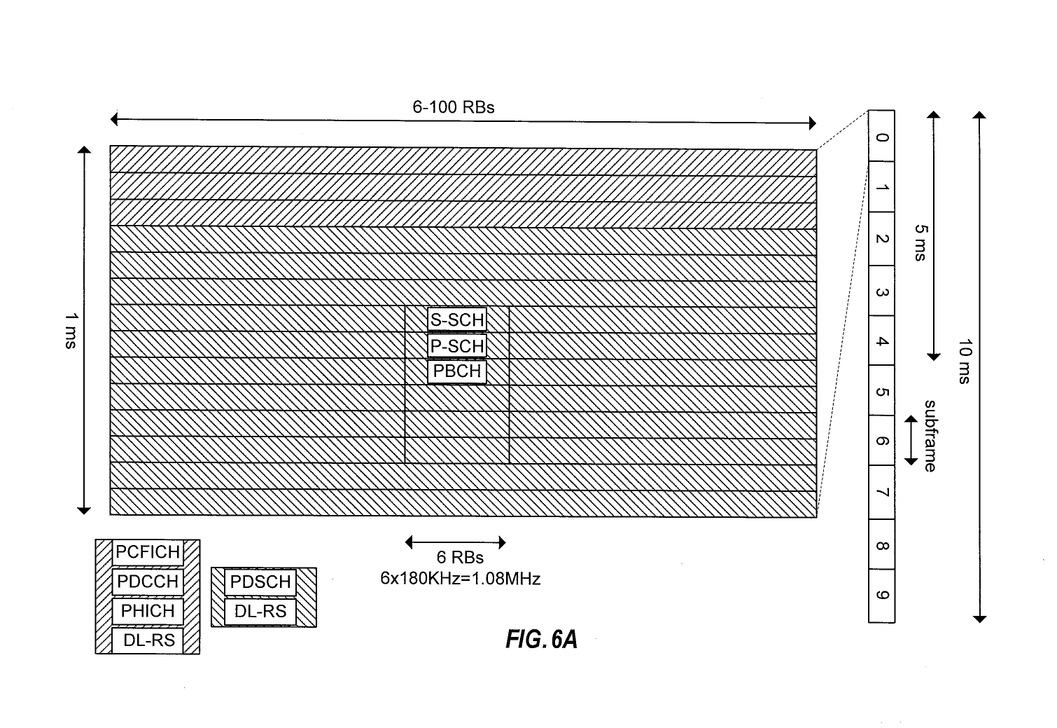

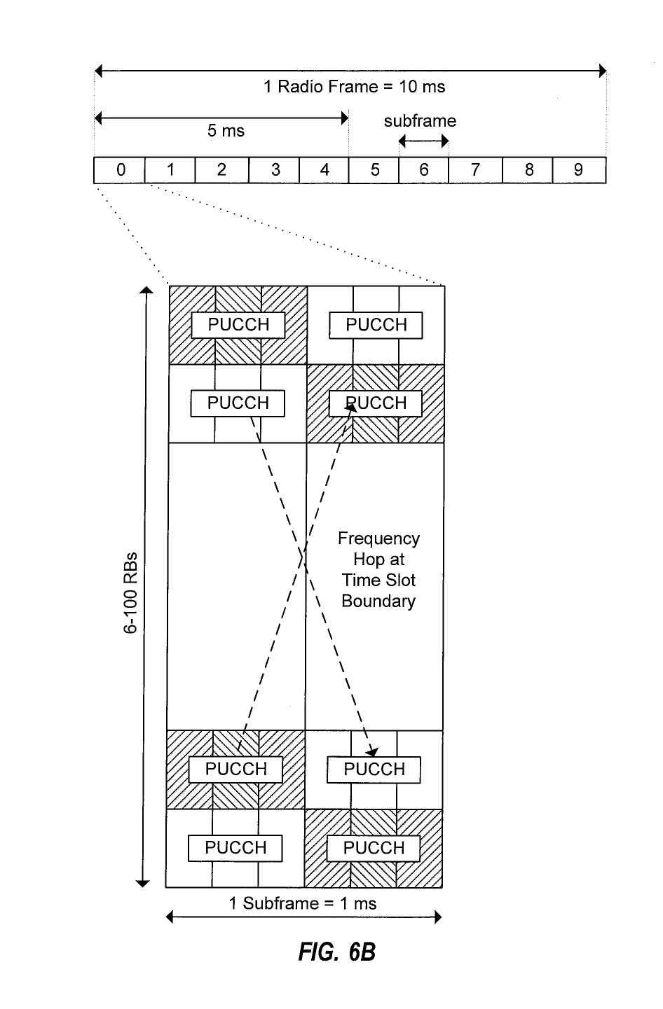

It should be appreciated that utilization of a smaller bandwidth than the cell actually broadcasts is generally not acceptable because the UE may fail decoding the channels that span the entire bandwidth or that are disposed around the edges. On the downlink, these physical channels may comprise, for example, PCFICH, PDCCH, and PHICH, which may be transmitted in resource elements that span the entire bandwidth of a subframe, including over the resource elements at the edge of the bandwidth, as shown in FIG. 6A. On the uplink, these physical channels may comprise PUCCH, which may be transmitted on resource elements at the edges of the cell bandwidth, as shown FIG. 6B. Without implementing a solution for the foregoing issue, a UE which is provided a smaller bandwidth than is supported by the SCell may not be able to successfully decode these channels.

Accordingly, network side operation adaptation is provided for implementing Partial Bandwidth Carrier Aggregation according to embodiments herein. For example, eNB 110 is adapted according to some embodiments to provide signaling (e.g., at the time of SCell addition), implement particular communication features, and/or provide appropriate scheduling control for Partial Bandwidth Carrier Aggregation. However, Carrier Aggregation capable UEs remain unmodified for operation of Partial Bandwidth Carrier Aggregation of embodiments.

In a Partial Bandwidth Carrier Aggregation implementation of embodiments, eNB 110 initiates cross-carrier scheduling with respect to UEs for which Partial Bandwidth Carrier Aggregation is invoked. Cross-carrier scheduling is a technique by which the UE is scheduled for downlink and/or uplink transmissions of one cell (e.g., a SCell) via a control channel (e.g., PDCCH) of another cell, such as a serving PCell or another SCell. When such cross-carrier scheduling is implemented with respect to a SCell assigned to the UE according to embodiments, the UE does not monitor the PCFICH or PDCCH of that cell. The PUCCH is present only on the PCell and thus the UE does not use the PUCCH region of the SCell according to embodiments. Similarly, with cross-carrier scheduling for a SCell, the PHICH of that cell is not monitored, although the UE may nevertheless monitor the PDSCH of the SCell, and perhaps transmit on the PUSCH of the SCell if uplink carrier aggregation is configured. Accordingly, with cross-carrier scheduling, the UE may be scheduled for a SCell via the PCell or another SCell. The eNB may send the UE ACKs on the PHICH of the cell on which the UL grants came. The starting position of the PDSCH of the SCell may be signaled to the UE via dedicated signaling according to embodiments.

Adaptation of network side infrastructure (e.g., eNB 110) to provide the foregoing cross-carrier scheduling may comprise deploying logic adapted to invoke existing cross-carrier scheduling functionality with respect to SCells for which Partial Bandwidth Carrier Aggregation is to be implemented. For example, logic of controller/processor 440 (e.g., software code or instructions stored in memory 442 and executed by controller/processor 440) of eNB 110a may be adapted to provide a Radio Resource Control (RRC) configuration command to UE 120b providing the parameters that apply with respect to the SCell for implementing UE wireless communication on the SCell. Such a configuration command may include a command for invoking cross-carrier scheduling functionality by the UE when Partial Bandwidth Carrier Aggregation is implemented. This configuration command may be provided to the UE by the eNB (e.g., using the PCell) through the air interface between eNB 110a and UE 120. Controller/processor 480 of the UE preferably responds to the command and configures the UE for Partial Bandwidth Carrier Aggregation operation. For example, in response to the cross-carrier scheduling command, controller/processor 480 of UE 120 may operate to ready the transmit and receive chains (e.g., transmit processor 464, TX MIMO processor 444 and MODs 454r of the transmit chain and MODs 454a, MIMO detector 456, and receive processor 458 of the receive chain) for SCell data-only communication with eNB 110a (i.e., control channels being provided by the PCell or another SCell). Thus, the cross-carrier scheduling initiated comprises cross-carrier scheduling functionality provided for carrier aggregation without SCell partial bandwidth support and is implemented without the cross-carrier scheduling functionality itself having been specifically adapted for SCell partial bandwidth support and/or without the UE having been specifically adapted for SCell partial bandwidth support according to embodiments herein.

Although facilitating Partial Bandwidth Carrier Aggregation, the invoking of the aforementioned cross-carrier scheduling does not fully address the issues with respect to the UE being assigned only a portion of the SCell bandwidth. For example, the cells generally broadcast a Master Information Block which includes important cell information, such as the bandwidth (i.e., the full bandwidth provided by the cell). However, in operation of Partial Bandwidth Carrier Aggregation, the UE will only be provided some portion of the bandwidth, wherein the bandwidth of the portion may vary depending upon the particular UE and/or situation according to embodiments of the invention. The UE should therefore not utilize the cell bandwidth information from the foregoing Master Information Block when Partial Bandwidth Carrier Aggregation is implemented.

Accordingly, eNB 110 of embodiments is further adapted to configure the UE for providing wireless communications for Partial Bandwidth Carrier Aggregation. For example, continuing with the foregoing exemplary configuration wherein eNB 110a is providing a PCell and is to provide a SCell, UE 120b may receive a RRC configuration command from eNB 110a (e.g., on the PCell), wherein the configuration command provides the partial bandwidth assignment (e.g., in the foregoing example, 10 MHz). Controller/processor 480 of the UE preferably responds to the command and configures the UE for Partial Bandwidth Carrier Aggregation operation. For example, in response to the bandwidth information of the configuration command, controller/processor 480 of UE 120 may operate to ready the transmit and receive chains (e.g., transmit processor 464, TX MIMO processor 444 and MODs 454r of the transmit chain and MODs 454a, MIMO detector 456, and receive processor 458 of the receive chain) for SCell wireless communication with eNB 110a within the designated bandwidth.

Having configured UE 120 for Partial Bandwidth Carrier Aggregation operation, eNB 110 of embodiments operates to provide downlink scheduling and/or uplink grant assignment for implementing the Partial Bandwidth Carrier Aggregation. In providing such downlink scheduling and uplink grant assignments for a UE for which Partial Bandwidth Carrier Aggregation is implemented, logic of scheduler 444 of embodiments of eNB 110 makes scheduling and grant assignments to that UE for the assigned, smaller bandwidth (e.g., 10 MHz instead of 20 MHz in the foregoing example) which may be implemented according to the concepts herein by controller/processor 440. For example, as shown in FIG. 5B, data communication with respect to UE 120b in the foregoing example is scheduled on the subcarriers disposed in the middle of the SCell bandwidth (i.e., the center 10 MHz of the 20 MHz bandwidth). Control information regarding the assignment of subcarriers, scheduling of resources, etc. for implementing the aforementioned SCell data communication may be provided by the serving PCell, such as using cross-carrier scheduling as described above. Having been configured for the smaller bandwidth, the transmit and/or receive chains of UE 120b utilize the bandwidth in accordance with the schedule/grants.

The SCell bandwidth which is not utilized by Partial Bandwidth Carrier Aggregation UE operation need not be unused according to embodiments of the invention. For example, data communications for UEs which are capable of utilizing the bandwidth beyond that of the Partial Bandwidth Carrier Aggregation assignment made to UE 120b, may be scheduled on the subcarriers which UE 120b is not utilizing (e.g., subcarriers of the 5 MHz bandwidth on either side of the 10 MHz of the Partial Bandwidth Carrier Aggregation assignment and/or subcarriers within the 10 MHz Partial Bandwidth Carrier Aggregation assignment which are not otherwise utilized by UE 120b).

It should be appreciated that application of a Partial Bandwidth Carrier Aggregation solution with respect to a particular UE according to embodiments may be more robust than simply assigning a partial bandwidth which does not exceed the currently unutilized capabilities of the UE. Embodiments of a Partial Bandwidth Carrier Aggregation enabled network may operate to implement control with respect to the UE in order to optimize the bandwidth available to the UE.

As an example of such optimization, a UE may be capable of supporting two carriers with a 20 MHz total aggregated bandwidth, but is nevertheless not capable of supporting 15 MHz+5 MHz (i.e., an exception). Such a situation may be the result of the UE resources (e.g., modem and receive chain) utilized by both 15 MHz bandwidth communication and 20 MHz bandwidth communication essentially being the same. Thus, when the UE is camped on a 15 MHz cell, no further bandwidth capacity remains although the UE is capable of 20 MHz total aggregated bandwidth (the “unused” bandwidth, here 5 MHz, being referred to herein as phantom capacity of the UE). Accordingly, although there may be an available cell providing 10 MHz bandwidth which could otherwise provide communication bandwidth to the UE, even implementation of Partial Bandwidth Carrier Aggregation facilitating the assignment of 5 MHz bandwidth may not be able to be used to increase the UE's communication bandwidth.

Optimization logic of embodiments herein (e.g., logic of controller/processor 440) may operate to implement changes to facilitate the assignment of additional bandwidth to the UE. For example, the UE may be controlled to implement a handoff from the 15 MHz bandwidth cell to the 10 MHz bandwidth cell. Thereafter, with the 10 MHz bandwidth cell acting as the PCell, Partial Bandwidth Carrier Aggregation may be implemented so that the UE is provided a partial bandwidth assignment of 10 MHz of the 15 MHz bandwidth cell resulting in the UE having 20 MHz bandwidth available for communications (i.e., 10 MHz+10 MHz).

From the above it can be appreciated that Partial Bandwidth Carrier Aggregation provided according to embodiments herein utilizes the network's bandwidth resources to a greater extent. If the UE is not camped on a cell or cells providing high enough bandwidth to meet peak data rate demand, and the bandwidth of the other cell or cells available to the UE exceed the UE's capabilities, then the network can use one of these cells with the higher bandwidth by implementing Partial Bandwidth Carrier Aggregation as described herein. This functionality is readily extendable to multiple component carriers (i.e., beyond the 2 of the foregoing embodiment, such as to utilize 3, 4, 5, etc. component carriers in various combinations of partial bandwidth assignments). Such techniques are expected to become more and more applicable with respect to future modem generations as the number of component carriers increases and multiple aggregate bandwidth limitations are present.

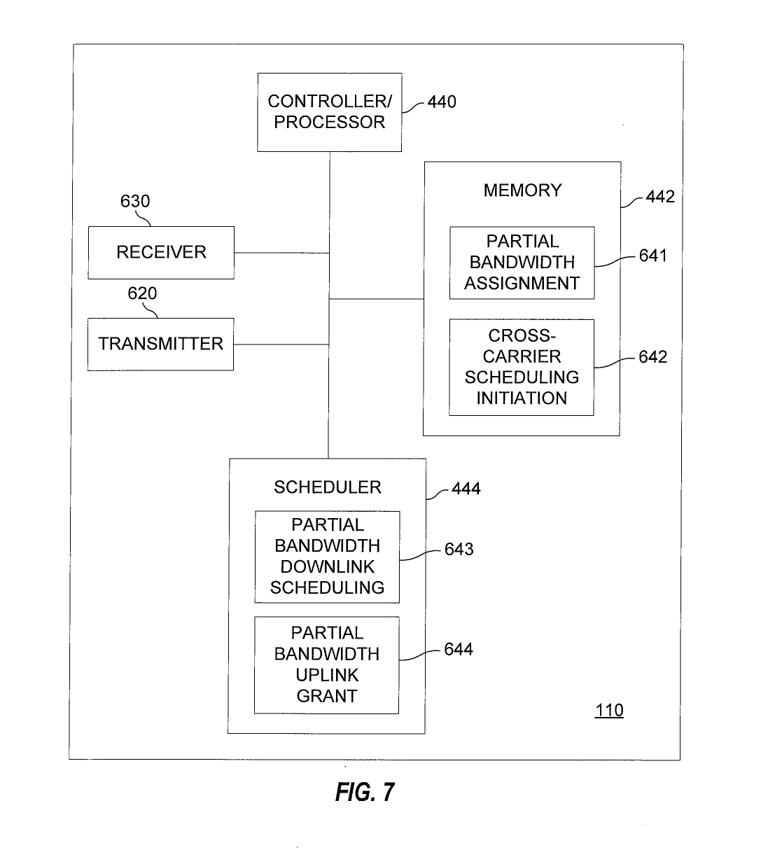

FIG. 7 is a block diagram illustrating eNB 110 configured according to one aspect of the present disclosure. As discussed with respect to FIG. 4 above, eNB 110 includes controller/processor 440 that controls and executes logic stored in memory 442 to implement the features and functionalities of eNB 110. In one aspect of the present disclosure, eNB 110 is adapted to provide partial bandwidth support of secondary cells for Partial Bandwidth Carrier Aggregation operable to enable the use of a portion of the secondary cell bandwidth to accommodate bandwidth limitations of a UE according to the concepts herein.

In operation according to embodiments, controller/processor 440 executes partial bandwidth assignment logic 641 stored in memory 442 to provide partial bandwidth assignment with respect to a UE for which Partial Bandwidth Carrier Aggregation is to be provided. Accordingly, partial bandwidth assignment logic 641 of embodiments operates to assign a portion of the communication bandwidth of a SCell to a UE, wherein the portion of the SCell bandwidth assigned may be less than the full bandwidth available from the SCell, as shown in block 801 of flow 800 in FIG. 8. Partial bandwidth assignment logic 642 may operate to determine an amount of capability with respect to communication bandwidth remaining available (e.g., unused bandwidth capability) for the UE, as may be reported by the UE via receiver 630 (e.g., comprising MODs 432t, MIMO detector 436, and receive processor 438), and to determine a cell which can be utilized to serve the communication bandwidth as a SCell through Carrier Aggregation. Where the bandwidth provided by that cell would exceed the aggregate bandwidth capability of the UE, partial bandwidth assignment logic 641 operates to make a partial bandwidth assignment (i.e., a bandwidth assignment of less than the communication bandwidth of the identified cell) for the UE.

Partial bandwidth assignment logic 641 may operate to provide signaling to the UE (e.g., in the form of a RRC configuration command transmitted from the eNB on the PCell), such as using transmitter 620 (e.g., comprising transmit processor 420, TX MIMO processor 480 and MODs 432), to provide the partial bandwidth assignment information to the UE. Additionally, partial bandwidth assignment logic 641 may operate to provide information to network side infrastructure, such as scheduler 444 of eNB 110 utilized in providing the SCell, for implementing downlink scheduling and/or uplink grants in accordance with the partial bandwidth assignment. For example, partial bandwidth assignment logic 641 may operate to send assignment and/or grant information for the assigned portion of the SCell communication bandwidth to the UE via a PCell in communication with the UE, as shown in block 802 of flow 800 in FIG. 8.

Partial bandwidth assignment logic 641 of embodiments may operate to provide functionality in addition to assigning a partial bandwidth which does not exceed the currently unutilized capabilities of the UE. For example, embodiments of partial bandwidth assignment logic 641 may operate to determine PCell and/or SCell assignments for optimizing the bandwidth provided to a UE and to initiate the appropriate control of infrastructure (whether network side or UE side) to implement such optimized configurations (e.g., unused communication bandwidth capability of the UE, including phantom capacity of the UE, may be made available and then utilized by optimization).

Controller/processor 440 of the illustrated embodiment further executes cross-carrier scheduling initiation logic 642 stored in memory 442 to implement cross-carrier scheduling with respect to a UE for which Partial Bandwidth Carrier Aggregation is to be provided. Cross-carrier scheduling initiation logic 642 may operate to initiate cross-carrier scheduling at the PCell and SCell (e.g., scheduler 444 of eNB 110) for communications associated with the UE for which Partial Bandwidth Carrier Aggregation is to be provided. Moreover, cross-carrier scheduling initiation logic 642 may provide signaling to the UE (e.g., in the form of a RRC configuration command transmitted from the eNB on the PCell), such as using transmitter 620, to implement cross-carrier scheduling operation by the UE.

Having configured both the network side infrastructure and the UE for Partial Bandwidth Carrier Aggregation, scheduling logic of scheduler 444 of the illustrated embodiment implements downlink scheduling and/or uplink grants in accordance with the partial bandwidth assignment. For example, partial bandwidth downlink scheduling logic 643 of the illustrated embodiment operates to provide downlink scheduling to implement Partial Bandwidth Carrier Aggregation. Correspondingly, partial bandwidth uplink grant logic 644 of the illustrated embodiment operates to provide uplink grant assignments to implement Partial Bandwidth Carrier Aggregation. Data communication (e.g., uplink and/or downlink communication) may thus be provided between the eNB and the UE using the assigned portion of the SCell bandwidth in accordance with the assignment and grant information, as shown in block 803 of flow 800 in FIG. 8. Control of scheduling and grant assignments in accordance with the partial bandwidth assignment according to embodiments comprises scheduling the communications associated with the UE to restrict the appropriate SCell communications to resources of the assigned portion of the communication bandwidth.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 4 and 6, for example, may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
assigning a portion of communication bandwidth of a secondary cell (SCell) to a user equipment (UE), wherein the portion of communication bandwidth of the SCell is less than a full bandwidth of the SCell;
sending information for the assignment of the portion of the SCell communication bandwidth to the UE using a primary cell (PCell) in communication with the UE; and
providing data communication with the UE using the portion of the SCell communication bandwidth in accordance with the information.

2. The method of claim 1, wherein the information for the assignment of the portion of the SCell communication bandwidth comprises resource grant information, the method further comprising:
scheduling the communications associated with the UE to restrict the communications which are communicated via the SCell to resources of the assigned portion of the communication bandwidth, wherein the grant information provides grants in accordance with the scheduling.

3. The method of claim 1, wherein the sending the information for the assignment of the portion of the SCell communication bandwidth comprises:
sending a Radio Resource Control (RRC) configuration command to the UE including parameters for the portion of the SCell communication bandwidth and a command to invoke cross-carrier scheduling functionality by the UE.

4. The method of claim 3, wherein the cross-carrier scheduling functionality comprises cross-carrier scheduling functionality provided for carrier aggregation without SCell partial bandwidth support and is implemented without the cross-carrier scheduling functionality itself having been specifically adapted for SCell partial bandwidth support.

5. The method of claim 4, wherein the SCell partial bandwidth support is provided without the UE having been specifically adapted for SCell partial bandwidth support.

6. The method of claim 1, further comprising:
determining an amount of communication bandwidth capability of the UE remaining available beyond the communication bandwidth capability associated with the PCell communication;
identifying a cell which can be utilized to serve the remaining communication bandwidth capability as the SCell; and
determining if a bandwidth provided by the identified cell would exceed an aggregate bandwidth capability of the UE, wherein the portion of communication bandwidth of the SCell assigned to the UE comprises a portion of the bandwidth provided by the identified cell which does not exceed the aggregate bandwidth capability of the UE.

7. The method of claim 2, wherein the communication bandwidth capability of the UE remaining available comprises communication capability selected from the group consisting of phantom capacity of the UE and communication bandwidth capability of the UE which although used may be made available by optimization.

8. The method of claim 1, further comprising:
changing at least one bandwidth assignment with respect to the UE to provide PCell and SCell bandwidth assignments to the UE which are optimized with respect to an aggregate bandwidth capability of the UE, wherein the changing at least one bandwidth assignment comprises implementing a change in a PCell assignment for the UE to facilitate the assignment of additional bandwidth to the UE via the SCell.

9. An apparatus configured for wireless communication, comprising:
means for assigning a portion of communication bandwidth of a secondary cell (SCell) to a user equipment (UE), wherein the portion of communication bandwidth of the SCell is less than a full bandwidth of the SCell;
means for sending information for the assignment of the portion of the SCell communication bandwidth to the UE using a primary cell (PCell) in communication with the UE; and
means for providing data communication with the UE using the portion of the SCell communication bandwidth in accordance with the information.

10. The apparatus of claim 9, wherein the information for the assignment of the portion of the SCell communication bandwidth comprises resource grant information, the apparatus further comprising:
means for scheduling the communications associated with the UE to restrict the communications which are communicated via the SCell to resources of the assigned portion of the communication bandwidth, wherein the grant information provides grants in accordance with the scheduling.

11. The apparatus of claim 9, wherein the means for sending the information for the assignment of the portion of the SCell communication bandwidth comprises:
means for sending a Radio Resource Control (RRC) configuration command to the UE including parameters for the portion of the SCell communication bandwidth and a command to invoke cross-carrier scheduling functionality by the UE.

12. The apparatus of claim 11, wherein the cross-carrier scheduling functionality comprises cross-carrier scheduling functionality provided for carrier aggregation without SCell partial bandwidth support and is implemented without the cross-carrier scheduling functionality itself having been specifically adapted for SCell partial bandwidth support.

13. The apparatus of claim 12, wherein the SCell partial bandwidth support is provided without the UE having been specifically adapted for SCell partial bandwidth support.

14. The apparatus of claim 9, further comprising:
means for determining an amount of communication bandwidth capability of the UE remaining available beyond the communication bandwidth capability associated with the PCell communication;
means for identifying a cell which can be utilized to serve the remaining communication bandwidth capability as the SCell; and
means for determining if a bandwidth provided by the identified cell would exceed an aggregate bandwidth capability of the UE, wherein the portion of communication bandwidth of the SCell assigned to the UE comprises a portion of the bandwidth provided by the identified cell which does not exceed the aggregate bandwidth capability of the UE.

15. The apparatus of claim 14, wherein the communication bandwidth capability of the UE remaining available comprises communication capability selected from the group consisting of phantom capacity of the UE and communication bandwidth capability of the UE which although used may be made available by optimization.

16. The apparatus of claim 9, further comprising:
means for changing at least one bandwidth assignment with respect to the UE to provide PCell and SCell bandwidth assignments to the UE which are optimized with respect to an aggregate bandwidth capability of the UE, wherein the means for changing at least one bandwidth assignment with respect to the UE comprises means for implementing a change in a PCell assignment for the UE to facilitate the assignment of additional bandwidth to the UE via the SCell.

17. A computer program product for wireless communications in a wireless network, comprising:
a non-transitory computer-readable medium having program code recorded thereon, the program code including:
program code to assign a portion of communication bandwidth of a secondary cell (SCell) to a user equipment (UE), wherein the portion of communication bandwidth of the SCell is less than a full bandwidth of the SCell;
program code to send information for the assignment of the portion of the SCell communication bandwidth to the UE using a primary cell (PCell) in communication with the UE; and
program code to provide data communication with the UE using the portion of the SCell communication bandwidth in accordance with the information.

18. The computer program product of claim 17, wherein the information for the assignment of the portion of the SCell communication bandwidth comprises resource grant information, the computer program product further comprising:
program code to schedule the communications associated with the UE to restrict the communications which are communicated via the SCell to resources of the assigned portion of the communication bandwidth, wherein the grant information provides grants in accordance with the scheduling.

19. The computer program product of claim 17, wherein the program code to send the information for the assignment of the portion of the SCell communication bandwidth comprises:
program code to send a Radio Resource Control (RRC) configuration command to the UE including parameters for the portion of the SCell communication bandwidth and a command to invoke cross-carrier scheduling functionality by the UE.

20. The computer program product of claim 19, wherein the cross-carrier scheduling functionality comprises cross-carrier scheduling functionality provided for carrier aggregation without SCell partial bandwidth support and is implemented without the cross-carrier scheduling functionality itself having been specifically adapted for SCell partial bandwidth support.

21. The computer program product of claim 20, wherein the SCell partial bandwidth support is provided without the UE having been specifically adapted for SCell partial bandwidth support.

22. The computer program product of claim 17, further comprising:
program code to determine an amount of communication bandwidth capability of the UE remaining available beyond the communication bandwidth capability associated with the PCell communication;
program code to identify a cell which can be utilized to serve the remaining communication bandwidth capability as the SCell; and
program code to determine if a bandwidth provided by the identified cell would exceed an aggregate bandwidth capability of the UE, wherein the portion of communication bandwidth of the SCell assigned to the UE comprises a portion of the bandwidth provided by the identified cell which does not exceed the aggregate bandwidth capability of the UE.

23. The computer program product of claim 17, further comprising:
program code to change at least one bandwidth assignment with respect to the UE to provide PCell and SCell bandwidth assignments to the UE which are optimized with respect to an aggregate bandwidth capability of the UE, wherein the program code to change at least one bandwidth assignment with respect to the UE comprises program code to implement a change in a primary cell (PCell) assignment for the UE to facilitate the assignment of additional bandwidth to the UE via the SCell.

24. An apparatus configured for wireless communication, the apparatus comprising:
at least one processor; and
a memory coupled to the at least one processor,
wherein the at least one processor is configured:
to assign a portion of communication bandwidth of a secondary cell (SCell) to a user equipment (UE), wherein the portion of communication bandwidth of the SCell is less than a full bandwidth of the SCell;
to send information for the assignment of the portion of the SCell communication bandwidth to the UE using a primary cell (PCell) in communication with the UE; and
to provide data communication with the UE using the portion of the SCell communication bandwidth in accordance with the information.

25. The apparatus of claim 24, wherein the information for the assignment of the portion of the SCell communication bandwidth comprises resource grant information, the at least one processor is further configured:
to schedule the communications associated with the UE to restrict the communications which are communicated via the SCell to resources of the assigned portion of the communication bandwidth, wherein the grant information provides grants in accordance with the scheduling.

26. The apparatus of claim 24, wherein the at least one processor configured to send the information for the assignment of the portion of the SCell communication bandwidth is configured:
to send a Radio Resource Control (RRC) configuration command to the UE including parameters for the portion of the SCell communication bandwidth and a command to invoke cross-carrier scheduling functionality by the UE.

27. The apparatus of claim 26, wherein the cross-carrier scheduling functionality comprises cross-carrier scheduling functionality provided for carrier aggregation without SCell partial bandwidth support and is implemented without the cross-carrier scheduling functionality itself having been specifically adapted for SCell partial bandwidth support.

28. The apparatus of claim 27, wherein the SCell partial bandwidth support is provided without the UE having been specifically adapted for SCell partial bandwidth support.

29. The apparatus of claim 24, wherein the at least one processor is further configured:
to determine an amount of communication bandwidth capability of the UE remaining available beyond the communication bandwidth capability associated with the PCell communication;
to identify a cell which can be utilized to serve the remaining communication bandwidth capability as the SCell; and
to determine if a bandwidth provided by the identified cell would exceed an aggregate bandwidth capability of the UE, wherein the portion of communication bandwidth of the SCell assigned to the UE comprises a portion of the bandwidth provided by the identified cell which does not exceed the aggregate bandwidth capability of the UE.

30. The apparatus of claim 24, wherein the at least one processor is further configured:
to change at least one bandwidth assignment with respect to the UE to provide PCell and SCell bandwidth assignments to the UE which are optimized with respect to an aggregate bandwidth capability of the UE, wherein the at least one processor configured to change the at least one bandwidth assignment with respect to the UE is configured to implement a change in a primary cell (PCell) assignment for the UE to facilitate the assignment of additional bandwidth to the UE via the SCell.
